(19) United States
(12) Patent Application Publication
(10) Pub. No.: US 2010/0205118 A1
(43) Pub. Date: Aug. 12, 2010

(54) OUTDOOR ADVERTISING METHOD

(76) Inventor: James H. Johnson, JR., Lexington, KY (US)

Correspondence Address: KING & SCHICKLI, PLLC, 247 NORTH BROADWAY, LEXINGTON, KY, 40507, US

(21) Appl. No.: 11/996,692

(22) PCT Filed: Jul. 24, 2006
(86) PCT No.: PCT/US06/28572

§ 371 Date: Jan. 24, 2008

Related U.S. Application Data
(60) Provisional application No. 60/702,476, filed on Jul. 26, 2005.
(60) Provisional application No. 60/758,761, filed on Jan. 13, 2006.
(60) Provisional application No. 60/759,758, filed on Jan. 18, 2006.

(51) Int. Cl. G06Q 90/00

(52) U.S. Cl. 705/500

(57) ABSTRACT

A method is provided for supplying low-cost storage space to a customer. The method includes the steps of providing the customer with a storage structure, retaining advertising rights on the storage structure and marketing advertising space on the storage structure. The customer is allowed to use the storage space in the storage structure at a nominal cost or cost free.

This application claims the benefit of U.S. Provisional Application Ser. Nos. 60/702,476 filed 26 Jul. 2005, 60/758,761, filed 13 Jan. 2006 and 60/759,758 filed 18 Jan. 2006.

### TECHNICAL FIELD

The present invention relates generally to the storage and outdoor advertising fields.

### BACKGROUND OF THE INVENTION

As a successful business grows, it generally has a need for more space in order to meet its need to provide customers with goods and/or services. Thus, many businesses today presently need additional storage space and/or inventory control. Generally they meet this need by either (a) changing locations, (b) making a substantial capital investment in a building expansion or c) renting mini-warehousing space at another, remote site.

For many businesses, relocating is not an option as the location itself is a key to the business. For many others insufficient capital is available for building expansion. Further, while mini-warehousing may be a viable option for some businesses, it is inconvenient since a trip is required to the remote site in order to retrieve needed items or supplies. Since a mini-warehouse location is lost when an employee is required to retrieve items. Further, with the cost of gasoline and the potential liability risk run when an employee is driving his or her vehicle in a business capacity, substantial expense is also incurred.

The present invention provides a fourth and for many businesses a better, alternative solution to the space problem.

### SUMMARY OF THE INVENTION

In accordance with the purposes of the present invention as described herein, a method is provided for supplying low-cost storage space and/or climate controlled inventory to a customer. That method may be broadly described as comprising providing the customer with a storage structure, retaining advertising rights on the storage structure and marketing advertising space on the storage structure.

The method may be further described as including the placing of the storage structure adjacent the customer's place of business and allowing the customer cost-free use of the internal storage space in that structure. Further the method may include the customizing of the internal storage space in the storage structure to meet the needs of the customer. In addition the method may include the customizing of the exterior of the storage structure to incorporate trade dress of the customer or other architectural features of the building occupied by the customer.

construction costs of the storage structure for the customer. The maintenance costs of the storage structure may also be absorbed for the customer. Thus the method may include the step of providing the storage structure substantially free to the customer.

Still further, the method may include the rotating of advertising provided on the storage structure. Further the method may include the back lighting of the advertising on the storage structure as well as providing short range radio advertising transmissions.

The storage structure may be constructed from modular building materials. Thus the method may include the steps of removing the storage structure following a predetermined period of time and subsequently reusing that storage structure at a different site.

Still further, the method may include the step of sharing revenue generated by marketing advertising space on the storage structure with the customer. In addition, the method may include owning and depreciating the storage structure.

In the following description there is shown and described a preferred embodiment of the invention, simply by way of illustration of one of the modes best suited to carry out the invention. As it will be realized, the invention is capable of other different embodiments and its several details are capable of modification in various, obvious aspects all without departing from the illustrative in nature and not as restrictive.

### BRIEF DESCRIPTION OF THE DRAWING

The accompanying drawing incorporated in and forming a part of this specification, illustrates several aspects of the present invention, and together with the description serves to explain certain principles of the invention. In the drawing:

FIG. 1 is a perspective view of a storage structure provided to a customer through the method of the present invention; and

FIG. 2 is a schematical end elevational view of a storage structure through the open end doors.

Reference will now be made in detail to the present preferred embodiment of the invention, an example of which is illustrated in the accompanying drawing.

### DETAILED DESCRIPTION OF THE INVENTION

As noted above the present method relates to the supplying of a low-cost storage space to a customer. The method may be generally and broadly described as including the steps of providing the customer with a storage structure, retaining advertising rights on the storage structure and marketing advertising space on the storage structure. Typically the method further

For a retailer, such placement includes being positioned next to the existing building from which the retailer operates. The method also includes allowing the customer use of the storage space either cost free or for a nominal charge.

The method may further include the customizing of the interior space in the storage structure to meet the needs of the customer. In addition the method may include customizing the exterior of the storage structure to incorporate the trade dress and/or building architecture of the customer.

In accordance with yet another aspect of the present invention, the method includes the absorbing of at least some, if not all of the material and construction costs of the storage space for the customer. In addition the method includes the absorbing of at least some, if not all of the maintenance costs of the storage structure for the customer. Accordingly, in at least one possible embodiment the method includes the providing of the storage structure substantially free to the customer.

In accordance with yet additional aspects of the present invention, the method includes the rotating of the advertising provided on the storage structure. In addition the method may include back lighting or down lighting the advertising so as to provide better visibility at night. In addition the method may include providing short range radio transmission advertising such as low wattage transmission on 89.1 FM. The transmitter may be located anywhere on the storage structure.

The method may also include the constructing of the storage structure from modular building materials. Further the method may include removing the storage structure following a predetermined period of time and subsequently reusing the storage structure at a different site. Still further, the method may include sharing revenue generated by marketing advertising on the storage structure with the customer. By owning the storage structure it is also possible to benefit from depreciation against any income generated by marketing advertising on the structure.

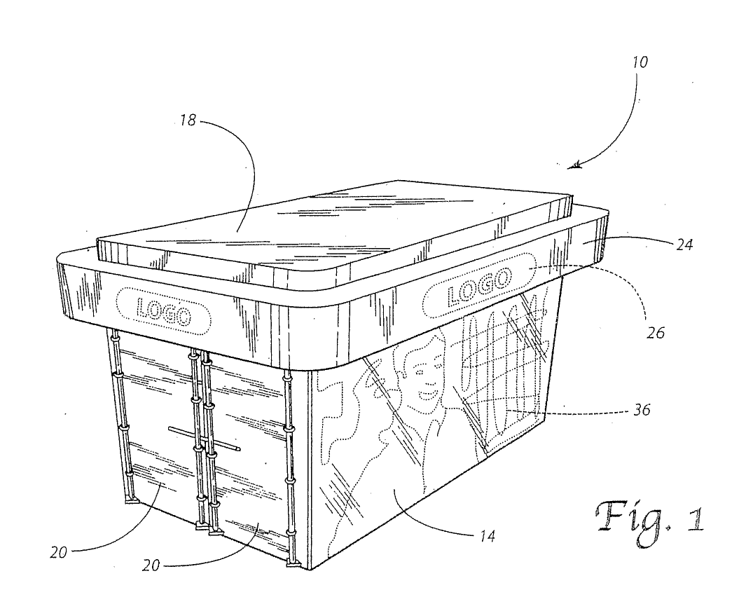

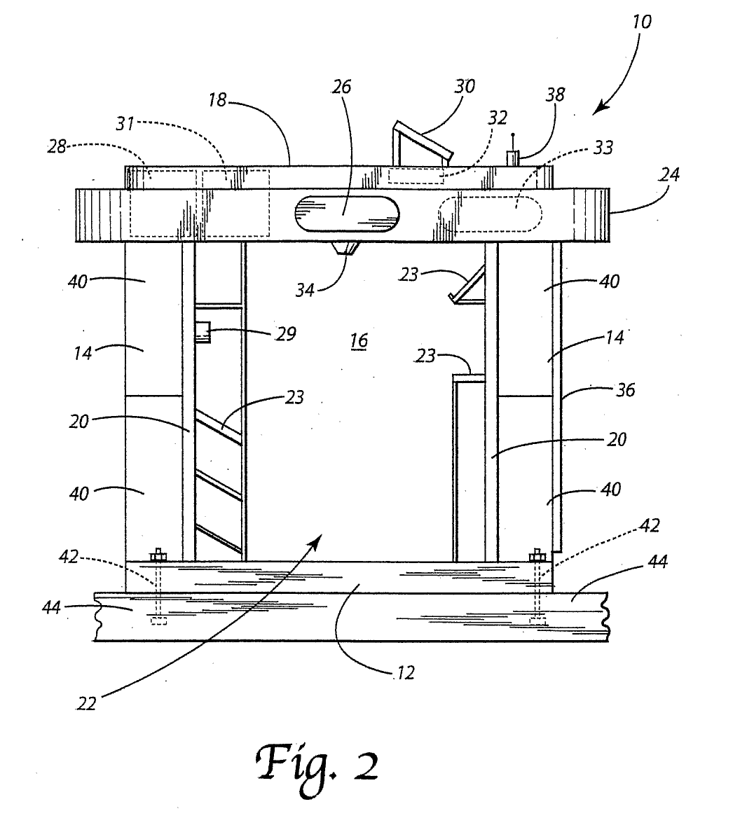

One possible construction of a storage structure a/k/a integrated advertising and storage structure 10 is illustrated in FIGS. 1-2. More specifically, the storage structure 10 includes a floor 12, two side walls 14, an end wall 16 and a roof 18. A pair of cooperating, locking doors 20 define a second end wall opposite the first end wall 16. Any type of door 20 useful for the intended purpose may be utilized. Together, the floor 12, side walls 14, end walls 16, roof 18 and doors 20 define an interior storage space 22. That storage space 22 may be customized to meet the customer's needs including particular rack, shelving, partitioning layouts (note shelves 23) as required or desired by the customer for purposes of inventory storage and control. The interior customization may be tailored to integrate with inventory control technology such as bar coding.

match the trade dress and/or architectural features of the customer's main building near which the storage structure 10 may be placed into service. Thus, for example, the storage structure 10 may include a decorative roof cap 24 sized and shaped to customer specifications. The roof cap 24 may include customer advertising, trade dress or logo 26 if desired and/or as allowed by local regulations.

The storage structure 10 may also be equipped with various electrical and/or mechanical systems. For example, a climate control unit such as an air conditioner, refrigerator, freezer, humidifier or dehumidifier 28 may be provided on the storage structure 10 in order to provide climate control of the storage space 22 within the storage structure. Accordingly, products such as perishable food, dairy products, soft drinks and beer may be maintained at the desired temperatures even in hot and humid environments.

In addition, the storage structure 10 may be equipped with a solar panel 30 and cooperating battery 32 to store energy for powering an internal lighting system 34 for illuminating the storage space 22 or illuminating advertising 36 on the side wall 14, end wall 16 or other exterior component of the storage structure 10. That advertising 36 may comprise a stretched banner material and it may be front lit or back lit as desired.

If desired, power for all the electrical and mechanical components of the storage structure 10 may be provided through an electrical circuit box 29 supplier. Alternatively, the housing 10 may carry an electric generator 31. In one possible embodiment, the generator 31 may be driven by natural gas and connected to the underground supply line of the local natural gas provider. In another possible embodiment, the generator 31 may be driven by propane and the structure may further include a propane storage tank 33 for supplying propane to the generator. Of course, that propane storage tank 33 could also be provided underground. In yet another alternative, the electric generator is powered by a fuel cell.

Still further, the storage structure 10 may incorporate a radio transmitter 38 for the transmission of short range advertisements respecting products displayed in the advertising 36 appearing on the exterior surface of the storage structure 10. A particularly effective advertising combination is the use of a backlit digital graphic advertising banner 36 in conjunction with local transmission radio advertising providing details of the particular product. This is particularly effective when advertising a product that is sold at the customer's place of business.

The storage structure 10 may be constructed from any appropriate material. The storage structure 10 could be constructed in the manner of a standard trailer or box truck and may or may not include additional architectural details. Alternatively, the storage structure 10 may be constructed from modular building materials such as prefabricated panels 40 of the type shown to Hesser and U.S. Pat. No. 6,119,427 to Wyman et al. Such modular panels typically incorporate a core of thermal insulating material sandwiched between metal or plastic sheathing. Such a construction provides the desired “R-factor” for both efficient and effective control of the temperature and humidity of the environment in the internal storage space 22 and excellent inclement weather durability for a long, low-maintenance service life. Structures 10 constructed from such modular building panels 40 are also characterized by high strength and will resist high winds and maintain a weather-tight enclosure to protect products held in the storage space 22 from inclement weather. In fact, such structures may be easily anchored to the ground such as by means of cooperating nut and bolt anchors 42 where the bolt is recessed and held in an underlying poured concrete pad 44. The modular panels 40 also allow the storage structure 10 to be quickly and easily erected and subsequently removed in a minimal amount of time while producing a minimum of mess.

In summary, numerous benefits result from employing the concepts of the present invention. The customer is essentially provided with a cost-free storage space in which the customer may store inventory or other material where they are protected from inclement weather. Advantageously, the storage space is also provided at a site selected by the customer. Such a site is typically conveniently located next to the customer's main building of business. Thus, for example, a convenience store operator may store an extra inventory of cold substantially cost-free, onsite storage provided by the present method is an attractive alternative when compared to leased, remotely located mini-warehousing.

The foregoing description of a preferred embodiment of the present invention has been presented for purposes of illustration and description. It is not intended to be exhaustive or to limit the invention to the precise form disclosed. Obvious modifications or variations are possible in light of the above teachings. For example, the advertising 36 may comprise the direct application of graphics to the panels 40 of the structure 10 and down lighting from a light source 42 in the roof cap 24 to illuminate those graphics. The structure 10 could also include an electronic display system such as a plasma monitor, liquid crystal display, a rotating sign assembly such as disclosed in U.S. Pat. No. 4,021,946, an electronic message board or the like to display advertising 36.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The ordinary meaning of the claims and their fair and broad interpretation in any way.

What is claimed:

1. A method of supplying low-cost storage space to a customer, comprising:
providing said customer with a storage structure;
retaining advertising rights on said storage structure; and
marketing advertising space on said storage structure.

2. The method of claim 1, further including placing said storage structure adjacent said customer's place of business and allowing said customer cost-free use of internal storage space in said storage structure.

3. The method of claim 1, further including customizing said internal storage space to meet the needs of said customer.

4. The method of claim 1, further including placing said storage structure adjacent said customer's place of business and allowing said customer use of internal storage space in said storage structure at a nominal cost.

5. The method of claim 1, further including customizing the exterior of said storage structure to incorporate trade dress or building architecture of said customer.

6. The method of claim 1, further including absorbing at least some material and construction costs of said storage structure for said customer.

7. The method of claim 6, further including absorbing at least some maintenance costs of said storage structure for said customer.

8. The method of claim 1, further including absorbing at least some maintenance costs of said storage structure for said customer.

9. The method of claim 1, further including absorbing material and construction costs of said storage structure for said customer.

10. The method of claim 9, further including absorbing maintenance costs of said storage structure for said customer.

11. The method of claim 1, further including absorbing maintenance costs of said storage structure for said customer.

12. The method of claim 1, including providing said storage structure substantially free to said customer.

13. The method of claim 1, further including providing climate control for an internal storage space of said storage structure.

14. The method of claim 1, including rotating advertising provided on said storage structure.

15. The method of claim 1, including illuminating advertising on said storage structure.

16. The method of claim 15, including providing short range radio advertising in a limited area around said storage structure.

17. The method of claim 1, including providing short range radio advertising in a limited area around said storage structure.

18. The method of claim 1, including constructing said storage structure from modular building materials.

19. The method of claim 18, including removing said storage structure after a predetermined period of time.

20. The method of claim 19, including reusing said storage structure at a different location.

21. The method of claim 1, further including providing said storage structure with a projecting roof cap and down lighting advertising provided on a wall of said storage structure with a light source carried by said roof cap.

22. The method of claim 1, further including sharing revenue generated by marketing advertising space on said storage structure with said customer.

23. The method of claim 1, further including owning and depreciating said storage structure.
